(19) United States
(12) Patent Application Publication
(10) Pub. No.: US 2009/0109008 A1
(43) Pub. Date: Apr. 30, 2009

(54) ANTI-THEFT DEVICE FOR MOTOR VEHICLE

(76) Inventors: Chung-Yi Kuo, Hsinchuang City (TW); Chin-Chang Lin, Taipei City (TW)

Correspondence Address: LEONG C LEI, PMB # 1008, 1867 YGNACIO VALLEY ROAD, WALNUT CREEK, CA, 94598, US

(21) Appl. No.: 12/253,243

(22) Filed: Oct. 17, 2008

(30) Foreign Application Priority Data
Oct. 31, 2007 (TW) 096218335

(51) Int. Cl. B60R 25/10

(52) U.S. Cl. 340/426.18; 340/426.25; 340/426.19; 340/426.13; 340/426.2; 348/148

(57) ABSTRACT

The anti-theft device contains a control circuit housed in a casing. The control circuit contains a microprocessor, a memory, a detection unit, a radio unit, and a GPS unit, and is connected to a supersonic sensor, a microwave sensor, an air-pressure sensor, and one ore more image capturing elements. When the motor vehicle is broken in, the control circuit detects such an event by evaluating the multiple signals collected by the sensors, and by processing the images captured by the image capturing elements. The control circuit then dials a preset numbers and plays a pre-recorded voice message asking for help. In the mean time, the continuous images captured by the image capturing elements are delivered a predetermined mobile phone or a computer so that the owner of the motor vehicle or some other people could monitor what is happening at the scene.

### TECHNICAL FIELD OF THE INVENTION

The present invention generally relates to anti-theft devices, and more particularly to an anti-theft device installed in a motor vehicle capable of sensing multiple signs of break-in, issuing alarm through wireless communication network, and performing video recording at the scene for later reference.

### DESCRIPTION OF THE PRIOR ART

Conventional anti-theft devices for motor vehicles are usually designed to work by detecting air pressure or vibration. The air-pressure-type anti-theft device senses the change of air pressure when the window or door is opened and then an alarm is triggered. The vibration-type anti-theft device senses the vibration or movement of the vehicle body and then an alarm is issued. However, for example, when the door is opened only very slightly or smoothly by a burglar, neither types of anti-theft device is capable of responding correctly. As such, the theft rate of motor vehicles is still rather significant.

In addition, except the deterrence to the burglar, conventional anti-theft devices usually cannot provide additional information about the situation at the scene to the owner of the motor vehicle. If the owner is at a remote place distance from where the motor vehicle is parked, the owner cannot judge whether the alarm is genuine and some action should be taken accordingly.

### SUMMARY OF THE INVENTION

Accordingly, a novel anti-theft device is provided herein which incorporate mobile communications in issuing real-time alarms and recording/delivering video and audio information.

The anti-theft device mainly contains a control circuit housed in a casing. The control circuit contains a microprocessor, a memory, a detection unit, a radio unit, and a GPS (Global Positioning System) unit, and connected to a supersonic sensor, a microwave sensor, and an air-pressure sensor. A clamping means is provided on the casing for fixing the anti-theft device to a rear-view mirror. One or more image capturing elements are provided on a front surface or the back surface of the casing, and a number of infrared light emitting diodes are provided along a circumference of the casing.

When the motor vehicle is broken in, the control circuit detects such an event by evaluating the multiple signals collected by the various sensors, and by processing the images captured by the image capturing element. The control circuit then could repeatedly dial one or more preset numbers and play a pre-recorded voice message asking for help once the call is answered. In the mean time, the continuous images captured by the image capturing element are delivered by the control circuit to a pre-determined mobile phone or a computer so that the owner of the motor vehicle or some other people could monitor, both visually and audibly, what is happening at the scene.

A socket connects a tire-pressure sensor and a battery sensor to the detection unit for constantly monitoring tire pressure and battery voltage. Further more, a Bluetooth unit, a microphone, and a speaker are provided so that the driver could conduct hands-free mobile communications and the owner could speak remotely to a burglar for deterrence.

A GPS receiver connected to the GPS unit is also provided so as to provide GPS positioning of the motor vehicle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an anti-theft device according to an embodiment of the present invention.

FIG. 2 is a perspective diagram showing the anti-theft device of FIG. 1 from a different viewing angle.

FIG. 3 is a block diagram showing the major functional blocks of the anti-theft device of the present invention.

FIG. 4 shows an application scenario of the anti-theft device of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

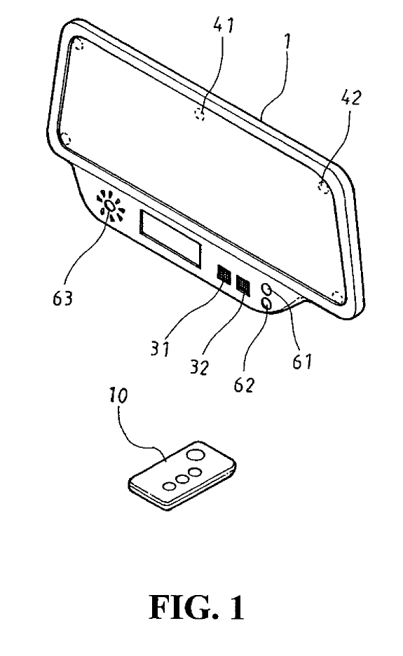

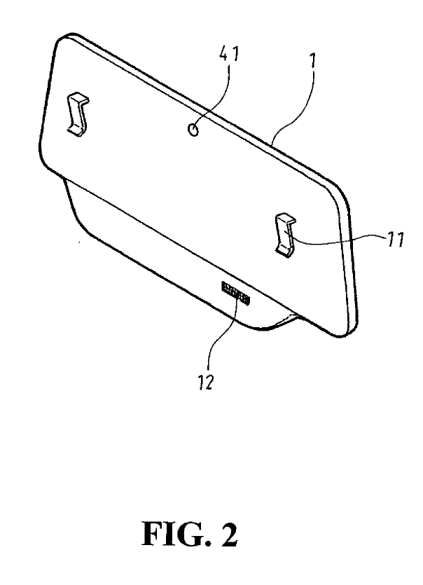

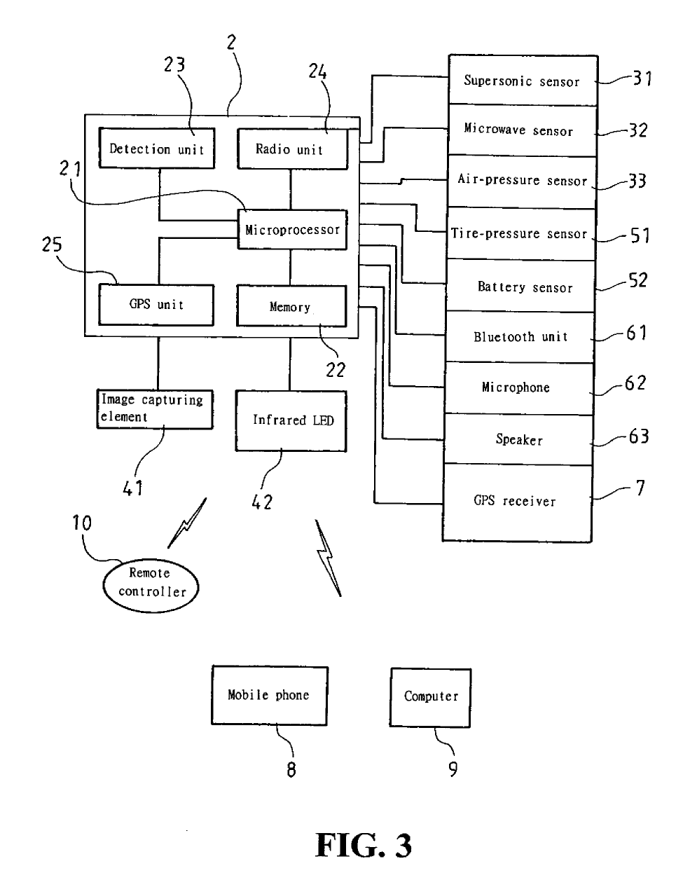

As shown in FIGS. 1 to 3, an anti-theft device according to an embodiment of the present invention mainly contains a control circuit 2 housed in a casing 1. The control circuit 2 contains a microprocessor 21, a memory 22, a detection unit 23, a radio unit 24, and a GPS (Global Positioning System) unit 25. The anti-theft device further contains a supersonic sensor 31, a microwave sensor 32, and an air-pressure sensor 33, all connected to the control circuit 2 and exposed from an outer surface of the casing 1. On a back surface of the casing 1, a clamping means 11 is provided for fixing the anti-theft device to a vizard or a rear-view mirror of the motor vehicle. The radio unit 24 is capable of conducting mobile communications in accordance with at least one of the standards such as GSM (2G, 2.5G), CDMA, PHS, 3G, 4G, and WIMAX.

One or more image capturing elements 41 are provided on a front surface or the back surface of the casing 1. Additionally, a number of infrared light emitting diodes (LEDs) 42 are provided along a circumference of the casing 1. A socket 12 is also exposed from the outer surface of the casing 1 so as to connect a tire-pressure sensor 51 and a battery sensor 52 to the detection unit 23 of the control circuit 2. Further more, a Bluetooth unit 61, a microphone 62, a speaker 63, and a GPS receiver 7 are also provided on the casing 1 and connected to the control circuit 2.

The anti-theft device as described above is clamped to a rear-view mirror or other place of the motor vehicle. When the motor vehicle is forced into or broken in, the control circuit 2 is able to detect such an event correctly by evaluating the multiple signals collected by the supersonic sensor 31, the microwave sensor 32, and the air-pressure sensor 33, and processing the images captured by the image capturing element 41. The control circuit 2 then could repeatedly dial one or more preset numbers and play a pre-recorded voice message asking for help once the call is answered. In the mean time, the continuous images captured by the image capturing element 41 are delivered by the control circuit to a pre-determined mobile phone 8 or a computer 9 so that the owner of the motor vehicle or some other people could monitor, both visually and audibly, what is happening at the scene.

Also when some emergency occurs, a driver or someone in or around the motor vehicle could instruct the anti-theft device by a remote controller 10 to ask for help as described above. In the mean time, the image capturing element 41 and the microphone 62 could lively record and delivers what is happening at the scene for later use as evidence.

Additionally, the connection of the detection unit 23 to the tire-pressure sensor 51 and the battery sensor 52 so that the anti-theft device could also constantly monitor the tire pressure and battery voltage and remind the driver of the motor vehicle to pump up the tires or recharge the battery. The GPS receiver 7 connected to the GPS unit 25 allows GPS positioning of the motor vehicle and provides the required coordinate information to an automated guidance system.

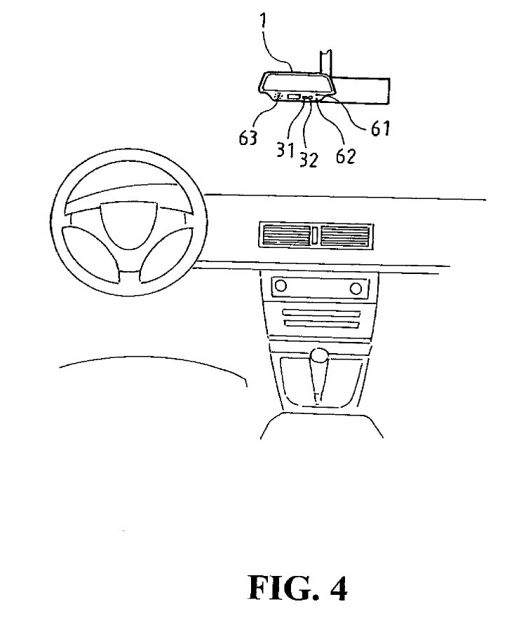

FIG. 4 shows an application scenario of the anti-theft device. As illustrated, the anti-theft device is clamped to the rear-view mirror. When the anti-theft device is turned on, control circuit 2 could store the continuous images of inside or outside the motor vehicle from the image capturing element 41 in the memory 22 for later retrieval. The control circuit 2 also performs motion detection based on these continuous images to see if there is unusual object movement inside or outside the motor vehicle. The supersonic sensor 31 and the microwave sensor 32 detect if there is any sign of breaking in. The air-pressure sensor 33, on the other hand, provides a separate detection to the breaking-in by sensing air-pressure variation.

As such, when a burglar breaks into the motor vehicle, the burglar's motion and disturbance could be picked up by multiple sensors and the image capturing element as described. Therefore, the chance of false alarm could be significantly reduced. Once a breaking-in is certain, the control circuit 2 repeatedly dials one or more preset numbers and plays a pre-recorded voice message asking for help once the call is answered. In the mean time, the continuous images captured by the image capturing element 41 are delivered by the control circuit 2 to a pre-determined mobile phone 8 or a computer 9 so that the owner of the motor vehicle or some other people could monitor, both visually and audibly, what is happening at the scene. In addition, the owner of the motor vehicle could remotely and proactively monitor the inside of the motor vehicle. The owner could call the SIM card number of the anti-theft device and, by the caller ID, the control circuit 2 could authenticate that the caller is indeed the owner. The control circuit 2 then could hang up the call immediately and start sending audio and video signals to the owner mobile phone or package the recorded audio and video signals in an electronic mail and send the mail to a preset electronic mail box, both through the radio unit 24. The owner could also send a SMS message to the SIM card number of the anti-theft deice. The control circuit 2 could then follow the owner's instruction to send images to the owner's mobile phone or electronic mail box. Further more, in the above detection and transmission process, the remote owner could even speak through the speaker 63 so as to deter the burglar.

In addition to the alarming function, the present invention could further provide the following function:

First, the socket 12 connects the tire-pressure sensor 51 and battery sensor 52 to the control circuit 2 so that the control circuit 2 is able to reminder the driver when the tires need to be pumped up or the battery need to be replaced or recharged. Secondly, the Bluetooth unit 61, together with the microphone 62 and speaker 63 allows the driver to answer or make mobile calls hands-free while driving. Thirdly, the GPS unit 25, connected to the GPS receiver 7, provides GPS positioning information. The remote controller 10, in addition to turning on and off the anti-theft device, could have an emergency button. When the emergency button is pressed, the control circuit 2 could call for help and the image capturing element 41 and the microphone 62 could lively record what is happening at the scene for later use as evidence, or deliver to a mobile phone 8 or to a computer 9 for storage.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An anti-theft device, comprising:
a casing;
a control circuit housed inside said casing, said control circuit having a microprocessor, a memory, a detection unit, and a radio unit;
a supersonic sensor, a microwave sensor, and an air-pressure sensor connected to said control circuit;
at least an image capturing element on a front surface or a back surface of said casing, said image capturing element being connected to said control circuit; and
a plurality of infrared LEDs along a circumference of said casing;
wherein, when said motor vehicle is broken in, said control circuit detects such an event by evaluating the multiple signals collected by said sensors, and by processing the images captured by said image capturing elements; said control circuit then dials a preset numbers and plays a pre-recorded voice message asking for help; and the continuous images captured by said image capturing elements are delivered to a pre-determined mobile phone or a computer so that what is happening at the scene could be monitored remotely.

2. The anti-theft device according to claim 1, further comprising:
a tire-pressure sensor and a battery sensor;
wherein said casing has a socket for connecting said tire-pressure sensor and said battery sensor to said detection unit of said control circuit for monitoring tire pressure and battery voltage of said motor vehicle.

3. The anti-theft device according to claim 1, further comprising:
a Bluetooth unit on said control circuit, a microphone and a speaker connected to said control circuit so as to provide hands-free communications of a driver of said motor vehicle.

4. The anti-theft device according to claim 1, further comprising:
a microphone and a speaker connected to said control circuit so as to collect sounds inside said motor vehicle and allow a remote speaker speaks directly through said speaker for deterrence.

5. The anti-theft device according to claim 1, further comprising:
a GPS unit on said control circuit and a GPS sensor connected to said GPS unit so as to provide global positioning of said motor vehicle.

6. The anti-theft device according to claim 1, wherein said radio unit is capable of conducting mobile communications in accordance with at least one of GSM 2G, GSM 2.5G, CDMA, PHS, 3G, 4G, and WIMAX.

7. The anti-theft device according to claim 1, wherein said casing has a clamping means on a back surface of said casing for fixing said anti-theft device to a location inside said motor vehicle:

8. The anti-theft device according to claim 1, further comprising:
a remote controller for tuning on and off said anti-theft device and sending out an alarm and recorded images for emergency.
